(19) United States
(12) Patent Application Publication
(10) Pub. No.: US 2014/0313745 A1
(43) Pub. Date: Oct. 23, 2014

(54) ILLUMINATION DEVICE

(71) Applicants: Cheng-Yen Chen, Tainan City (TW); Mei-Chun Shih, Tainan City (TW); Yi-Chun Shih, Tainan City (TW)

(72) Inventors: Cheng-Yen Chen, Tainan City (TW); Mei-Chun Shih, Tainan City (TW); Yi-Chun Shih, Tainan City (TW)

(73) Assignee: GENESIS PHOTONICS INC., Tainan City (TW)

(21) Appl. No.: 14/017,322

(22) Filed: Sep. 4, 2013

(30) Foreign Application Priority Data
Apr. 18, 2013 (TW) 102113814

(51) Int. Cl. F21V 1/00

(52) U.S. Cl. CPC F21V 1/00
USPC 362/311.03

(57) ABSTRACT

An illumination device including at least one light emitting element and a transparent lampshade is provided. The transparent lampshade is disposed on one side of the light emitting element and located on a light emitting path of the light emitting element. The transparent lampshade has a sealed space, a first fluid and a second fluid. The first fluid is a colloidal solution, and the first fluid is immiscible with the second fluid, and the first fluid and the second fluid flow in the sealed space to change a light shape of the emitted light from the light emitting element.

### CROSS-REFERENCE TO RELATED APPLICATION

This application claims the priority benefit of Taiwan application serial no. 102113814, filed on Apr. 18, 2013. The entirety of the above-mentioned patent application is hereby incorporated by reference herein and made a part of this specification.

### BACKGROUND OF THE INVENTION

1. Field of the Invention

The present invention generally relates to an illumination device, and more particularly, to an illumination device which uses a light emitting diode (LED) chip as a light source.

2. Description of Related Art

Because of the superior characteristics of saving power and being environmentally friendly, the high power LEDs have been rapidly developed, and thus they have replaced the conventional incandescent lamps and have become a mainstream for illumination light sources. In addition, since light emitting diodes are directional light emitting devices, in order to improve the light intensity distribution, the LEDs are generally used with a lampshade in the application of illumination devices. However, the location of the LED and the lampshade is fixed, and the shape of the lampshade is also geometrically fixed. Therefore, users cannot adjust the light shape of the emitted light from the illumination devices as required.

### SUMMARY OF THE INVENTION

The present invention provides an illumination device in which the light shape of the emitted light can be adjusted to form illuminating regions distributed in different sizes, different shapes and different intensity.

The illumination device of the present invention includes at least one light emitting element and a transparent lampshade. The transparent lampshade is disposed on one side of the light emitting element and located on a light emitting path of the light emitting element. The transparent lampshade has a sealed space, a first fluid and a second fluid. The first fluid is a colloidal solution, the first fluid is immiscible with the second fluid, and the first fluid and the second fluid flow in the sealed space so as to change the light shape of the emitted light from the light emitting element.

According to one exemplary embodiment of the present invention, both the first fluid and the second fluid are liquids and the first fluid and the second fluid fill up the sealed space.

According to one exemplary embodiment of the present invention, a difference value between a specific gravity of the first fluid and a specific gravity of the second fluid is equal to or greater than 3% of the specific gravity of the second fluid.

According to one exemplary embodiment of the present invention, a difference between a transmittance of the first fluid and a transmittance of the second fluid is equal to or greater than 5%.

According to one exemplary embodiment of the present invention, a dispersing medium of the first fluid is a liquid.

According to one exemplary embodiment of the present invention, a difference value between a scattering coefficient of the first fluid and a scattering coefficient of the second fluid is equal to or greater than 5% of the scattering coefficient of the second fluid.

According to one exemplary embodiment of the present invention, the first fluid includes at least one metal particle, and a diameter of the at least one metal particle is between 1 nm and 500 nm.

According to one exemplary embodiment of the present invention, the illumination device further includes a carrier, wherein the light emitting element is disposed on the carrier and located between the carrier and the transparent lampshade.

The illumination device of the present invention includes at least one light emitting element and a transparent lampshade. The light emitting element is disposed in the transparent lampshade, and at least a portion of the light emitting element is attached to the transparent lampshade. The transparent lampshade has a sealed space, a first fluid and a second fluid, wherein the first fluid is a colloidal solution, and the first fluid is immiscible with the second fluid, and the first fluid and the second fluid flow in the sealed space.

The illumination device of the present invention includes at least one light emitting element and a transparent lampshade. At least a portion of the light emitting element is embedded in the transparent lampshade, and the light emitting element and the transparent lampshade define a sealed space. The transparent lampshade has a first fluid and a second fluid, wherein the first fluid is immiscible with the second fluid, and the first fluid and the second fluid flow in the sealed space.

According to one exemplary embodiment of the present invention, the light emitting element is a light emitting diode, and a first electrode and a second electrode of the light emitting diode are respectively located at the inner side and the outer side of the sealed space.

According to one exemplary embodiment of the present invention, the first fluid and the second fluid are fluids with different conductivity, and the light emitting element directly contacts with the first fluid or the second fluid so as to form a conducting path or a non-conducting path.

According to one exemplary embodiment of the present invention, the transparent lampshade further has a third fluid, and the third fluid is a gas, and at least one of the first fluid and the second fluid is a conductive liquid. The light emitting element directly contacts with the conductive liquid or the gas to form a conducting path or a non-conducting path.

In light of the above, the transparent lampshade of the present invention has the first fluid and the second fluid which flow in the sealed space and are immiscible with each other, and the design of the transparent lampshade is adapted to change the light shape of the emitted light from the light emitting element. Accordingly, the user can change the light shape of the emitted light from the illumination device of the present invention by reversing the transparent lampshade, and so as to form illuminating regions distributed in different sizes, different shapes and different intensity.

Several exemplary embodiments accompanied with figures are described in detail below to further describe the invention in details.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the invention.

FIG. 1A is a schematic view illustrating an illumination device according to an embodiment of the present invention.

FIG. 1B is a schematic view of the illumination device illustrating after reversing the transparent lampshade of FIG. 1A.

FIG. 1C is a schematic view illustrating an illumination device according to another embodiment of the present invention.

FIG. 2 is a schematic view illustrating an illumination device according to another embodiment of the present invention.

FIG. 3A is a schematic view illustrating an illumination device according to another embodiment of the present invention.

FIG. 3B is a schematic view of the illumination device illustrating after reversing the transparent lampshade of FIG. 3A.

FIG. 4A is a schematic view illustrating an illumination device according to another embodiment of the present invention.

FIG. 4B is a schematic view of the illumination device illustrating after reversing the transparent lampshade of FIG. 4A.

FIG. 5A is a schematic view illustrating an illumination device according to another embodiment of the present invention.

FIG. 5B is a schematic view of the illumination device illustrating after reversing the transparent lampshade of FIG. 5A.

FIG. 6A is a schematic view illustrating an illumination device according to another embodiment of the present invention.

FIG. 6B is a schematic view of the illumination device illustrating after reversing the transparent lampshade of FIG. 6A.

### DESCRIPTION OF EMBODIMENTS

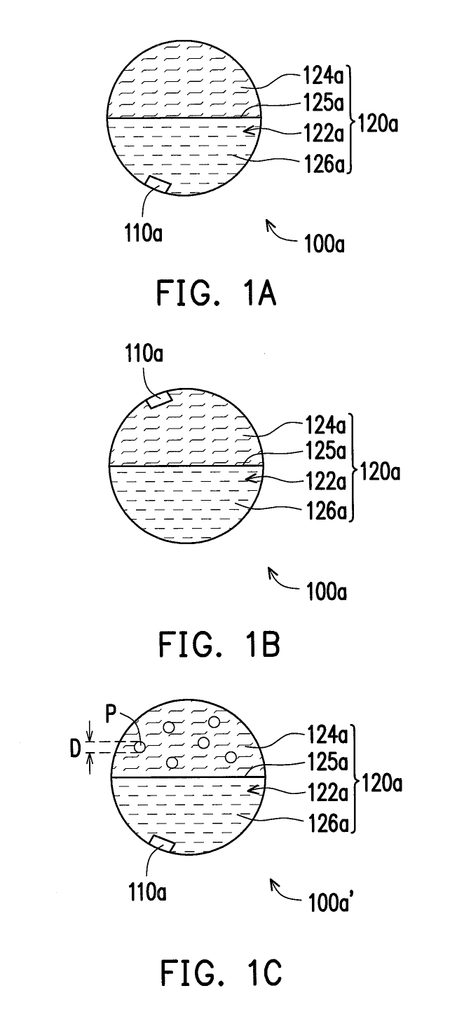

FIG. 1A is a schematic view illustrating an illumination device according to an embodiment of the present invention. Please refer to FIG. 1A. In the embodiment, the illumination device 100a includes at least one light emitting element 110a and a transparent lampshade 120a. The light emitting element 110a is disposed in the transparent lampshade 120a, and at least one portion of the light emitting element 110a is attached to the transparent lampshade 120a. The transparent lampshade 120a has a sealed space 122a, a first fluid 124a and a second fluid 126a. Specifically, the first fluid 124a is a colloidal solution. The first fluid 124a is immiscible with the second fluid 126a, and the first fluid 124a and the second fluid 126a flow in the sealed space 122a so as to change the light shape of the emitted light from the light emitting element 110a.

More specifically, the light emitting element 110a of the embodiment is a packaged LED chip, for example, wherein the LED chip is a vertically LED chip, a horizontally LED chip, or a flip-chip LED chip, and the present invention is not limited thereto. In addition, in the embodiment, the first fluid 124a and the second fluid 126a fill up the sealed space 122a of the transparent lampshade 120a, wherein the first fluid 124a and the second fluid 126a can be liquids or gases. Preferably, a dispersing medium of the first fluid 124a is a liquid, and the second fluid 126a is also a liquid. As such, the amount of the first fluid 124a and the amount of the second fluid 126a can easily be controlled, and the manufacturing process can also be simple. The first fluid 124a is immiscible with the second fluid 126a and a fluid contact interface 125a is formed therebetween. Since the first fluid 124a is a colloidal solution having a light scattering function, the emitted lights generate scattering effect on the fluid contact interface 125a of the first fluid 124a and the second fluid 126a. Herein, the external shape of the transparent lampshade 120a is a circle, for example, and the sealed space 122a is a circular sealed space. However, the external shape of the transparent lampshade 120a is not limited to be circular, and the shape of the transparent lampshade 120a can be any other shape such as a calabash shape, a rectangular shape or the like as mentioned in the following embodiments, and the present invention is not limited thereto.

Especially, a difference value between a specific gravity of the first fluid 124a and a specific gravity of the second fluid 126a is equal to or greater than 3% of the specific gravity of the second fluid 126a. In other words, if the delamination of the first fluid 124a and the second fluid 126a is more distinct, it becomes easier to facilitate the control of light shape of the illumination device 100a. As shown in FIG. 1A, since the specific gravity of the first fluid 124a is smaller than the specific gravity of the second fluid 126a, the first fluid 124a is located upon the second fluid 126a, and the second fluid 126a encloses the light emitting element 110a. When the user reverses the transparent lampshade 120a, referring to FIG. 1B, since the specific gravities are different, consequently, the first fluid 124a encloses the light emitting element 110a.

Moreover, the first fluid 124a and the second fluid 126a can have different transmittance, preferably, a difference value between a transmittance of the first fluid 124a and a transmittance of the second fluid 126a is equal to or greater than 5%, so that there exists a distinct light intensity difference between the first fluid 124a and the second fluid 126a and the light shape of the emitted light from the illumination device 100a can be changed through the flowing first fluid 124a and the flowing second fluid 126a.

For instance, if the first fluid 124a is oil and the second fluid 126a is water, the first fluid 124a is located upon the second fluid 126a due to the difference of the specific gravity, and the transmittance of the second fluid 126a is greater than the first fluid 124a. Therefore, the light emitted from the light emitting element 110a may form illuminating regions on the fluid contact interface 125a formed between the first fluid 124a and the second fluid 126a, so that the light shape is changed. In addition, phenomena of refraction, scattering or reflection may be formed on the fluid contact interface 125a, and these phenomena may also change the light shape of the emitted light from the light emitting element 110a.

It should be noted that, as shown in FIG. 1A and FIG. 1B, the fluid contact interface 125a formed by the first fluid 124a and the second fluid 126a is substantially a horizontal surface. However, in other embodiments which are not shown in the drawings, the fluid contact interface formed by the first fluid and the second fluid can be a non-planar surface (e.g., a curved surface or an inclined surface) due to surface tension or other reasons. Said embodiment still belongs to a technical means adoptable in the present invention and falls within the protection scope of the present invention.

Furthermore, it should be noted that, a scattering coefficient of the first fluid 124a and that of the second fluid 126a are different. Preferably, a difference value between a scattering coefficient of the first fluid 124a and a scattering coefficient of the second fluid 126a is equal to or greater than 5% of the scattering coefficient of the second fluid 126a. The light scattering phenomenon of the fluid contact interface 125a can be more distinct because of the scattering coefficient difference. In another embodiment, referring to the illumination device 100a′ of FIG. 1C, scattering particles such as metal particles P, dyes or the like can be added to the first fluid 124a as desired, wherein the diameter D of the metal particle P ranges between 1 nm and 500 nm, so that the reflection and scattering function of the first fluid 124a can be enhanced so as to achieve the effect of changing the light shape of the emitted light from the light emitting element 110a. Alternatively, the first fluid 124a and the second fluid 126a may have different conductivity, wherein the first fluid 124a is a conductive liquid while the second fluid 126a is an insulating fluid, for example. The light emitting element is controlled to be conducting or non-conducting through the fluids with different conductivity. Alternatively, the volume of the first fluid 124a and the volume of the second fluid 126a are different, so that the light shape of the emitted light from the illumination device 100a can be changed in the embodiment, and illuminating regions distributed in different sizes, different shapes and different intensity can further be formed.

It has to be described that reference numbers of the components and a part of contents of the aforementioned exemplary embodiments are also used in the following exemplary embodiments, wherein the same reference numbers denote the same or like components, and descriptions of the same technical contents are omitted. The aforementioned exemplary embodiments can be referred for descriptions of the omitted parts, so that detailed descriptions thereof are not repeated in the following exemplary embodiments.

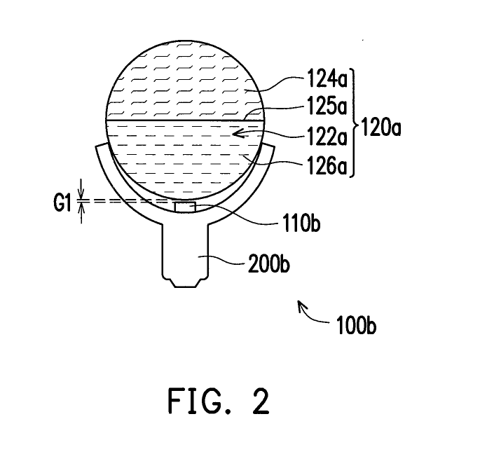

FIG. 2 is a schematic view illustrating an illumination device according to another embodiment of the present invention. Referring to FIG. 2, the illumination device 100b of the present embodiment is similar to the illumination device 100a of FIG. 1A, and the difference between the two illumination devices is that the light emitting element 110b is not disposed in the transparent lampshade 120a and located outside of the transparent lampshade 120a. More specifically, the transparent lampshade 120a is disposed at one side of the light emitting element 110b and located on a light emitting path of the light emitting element 110b.

In more detailed, the illumination device 100b further includes a carrier 200b, wherein the light emitting element 110b is disposed on the carrier 200b and located between the carrier 200b and the transparent lampshade 120a. The transparent lampshade 120a leans against the carrier 200b and is apart from the light emitting element 110b at a gap distance G1, wherein the gap distance G1 is equal to or greater than 0. Herein the carrier 200b is a lampstand, for example, and the present invention is not limited thereto.

The transparent lampshade 120a of the present invention has the first fluid 124a and the second fluid 126a which flow in the sealed space 122a and are immiscible with each other, and the design of the transparent lampshade 120a is adapted to change the light shape of the emitted light from the light emitting element 110b. Accordingly, the user can change the light shape of the emitted light from the illumination device 100b of the present invention by reversing the transparent lampshade 120a, and so as to form illuminating regions distributed in different sizes, different shapes and different intensity.

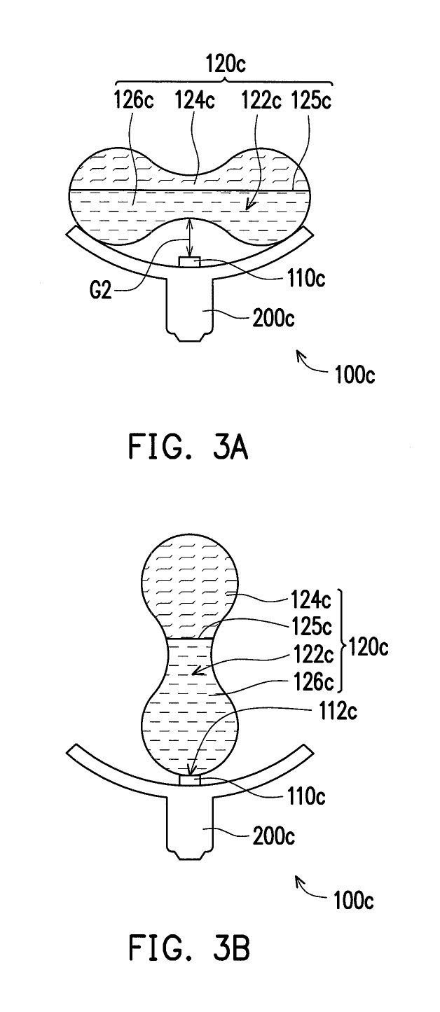

FIG. 3A is a schematic view illustrating an illumination device according to another embodiment of the present invention. FIG. 3B is a schematic view of the illumination device illustrating after reversing the transparent lampshade of FIG. 3A. Referring to FIG. 3A, the illumination device 100c of the present embodiment is similar to the illumination device 100b of FIG. 2, and the difference between the two illumination devices is that the shape of the transparent lampshade 120c is a calabash shape, and the sealed space 122c is a calabash-shaped sealed space, for example. As shown in FIG. 3A and FIG. 3B, the first fluid 124c and the second fluid 126c flow in the sealed space 122c by revering the transparent lampshade 120c, so as to change the distributing positions, so that the light shape of the emitted light from the illumination device 100c is changed, and there can be a gap distance G2 between the transparent lampshade 120c and the light emitting element 110c, wherein the gap distance G2 is equal to or greater than 0.

For instance, if the first fluid 124c is oil and the second fluid 126c is water, since the first fluid 124c is located upon the second fluid 126c due to the different specific gravity and being immiscible with each other, and the transmittance of the second fluid 126c is greater than the transmittance of the first fluid 124c. Therefore, the lights may be gathered up at the fluid contact interface 125c of the immiscible first fluid 124c and second fluid 126c and emitted. Accordingly, the illuminating region formed in the illumination device 100c of FIG. 3A is significantly larger than the illuminating region formed in the illumination device 100c of FIG. 3B, but the intensity distribution of the illumination device 100c of FIG. 3B is more concentrated than the intensity distribution of the illumination device 100c of FIG. 3A. Namely, the light shape generated by the illumination device 100c of FIG. 3A is different from the light shape generated by the illumination device 100c of FIG. 3B. Accordingly, the user can change the light shape of the emitted light from the illumination device 100c of the present invention by reversing the transparent lampshade 120c, and so as to form illuminating regions distributed in different sizes, different shapes and different intensity. In addition, the emitted light from the light emitting element 110c may form phenomena of refraction, scattering or reflection on the fluid contact interface 125c formed by the first fluid 124c and the second fluid 126c, and these phenomena may also change the light shape of the emitted light from the light emitting element 110c.

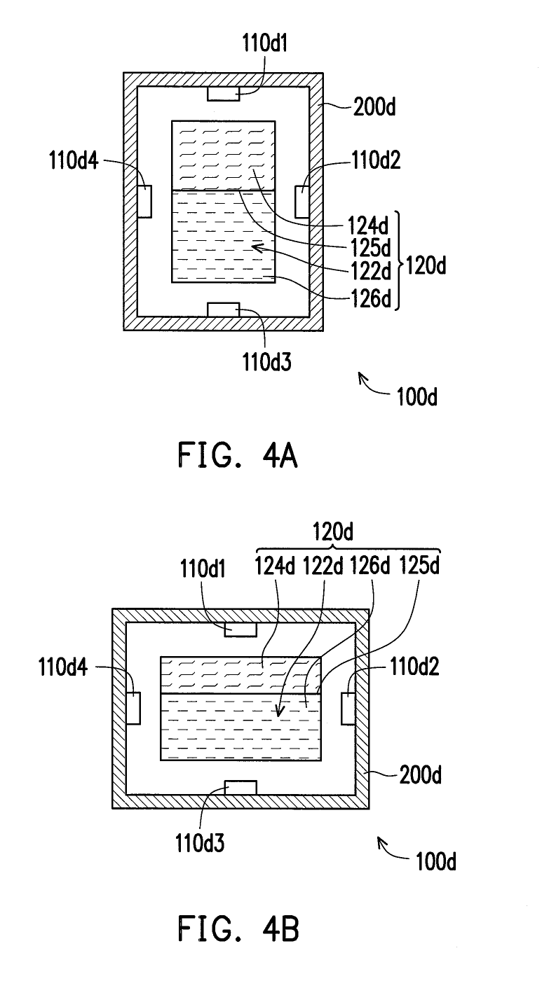

FIG. 4A is a schematic view illustrating an illumination device according to another embodiment of the present invention. FIG. 4B is a schematic view of the illumination device illustrating after reversing the transparent lampshade of FIG. 4A. Referring to FIG. 4A, the illumination device 100d of the present embodiment is similar to the illumination device 100b of FIG. 2, and the difference between the two illumination devices is that the carrier 200d of the illumination device 100d is a hollow frame, and the illumination device 100d has a plurality of light emitting elements 110d1, 110d2, 110d3, 110d4. The light emitting elements 110d1, 110d2, 110d3, 110d4 are disposed on the carrier 200d and electrically insulated from one another, wherein the carrier 200d surrounds the transparent lampshade 120d, and the light emitting elements 110d1, 110d2, 110d3, 110d4 are located between the carrier 200d and the transparent lampshade 120d. Herein the external shape of the transparent lampshade 120d is a rectangle, and the sealed space 122d is a rectangular sealed space, for example, but the present invention is not limited thereto.

As shown in FIG. 4A and FIG. 4B, for instance, if the first fluid 124d is oil and the second fluid 126d is water, since the first fluid 124d and the second fluid 126d are immiscible with each other and the specific gravity of the second fluid 126d is greater than the specific gravity of the first fluid 124d, the phenomenon that the first fluid 124d being located upon the second fluid 126d may be formed. In addition, since the volume of the second fluid 126d is significantly larger than that of the first fluid 124d in this embodiment, when the user reverses the transparent lampshade 120d, due to the transparent lampshade 120d being rectangular shape, the thicknesses and the distribution positions of the first fluid 124d and the second fluid 126d may be different obviously before and after reversing. Moreover, since the light emitting elements 110d1, 110d2, 110d3, 110d4 are electrically insulated from one another, the turning on and off of the light emitting elements 110d1, 110d2, 110d3, 110d4 can be decided as required. Accordingly, the user can change the light shape of the emitted light from the illumination device 100d of the present invention by reversing the transparent lampshade 120d and control to turn on/off the light emitting elements 110d1, 110d2, 110d3, 110d4, and so as to form illuminating regions distributed in different sizes, different shapes and different intensity. In addition, the emitted light from the light emitting elements 110d1, 110d2, 110d3, 110d4 may form phenomena of refraction, scattering or reflection on the fluid contact interface 125d formed by the first fluid 124d and the second fluid 126d, and these phenomena may also change the light shape of the emitted light from the light emitting elements 110d1, 110d2, 110d3, 110d4.

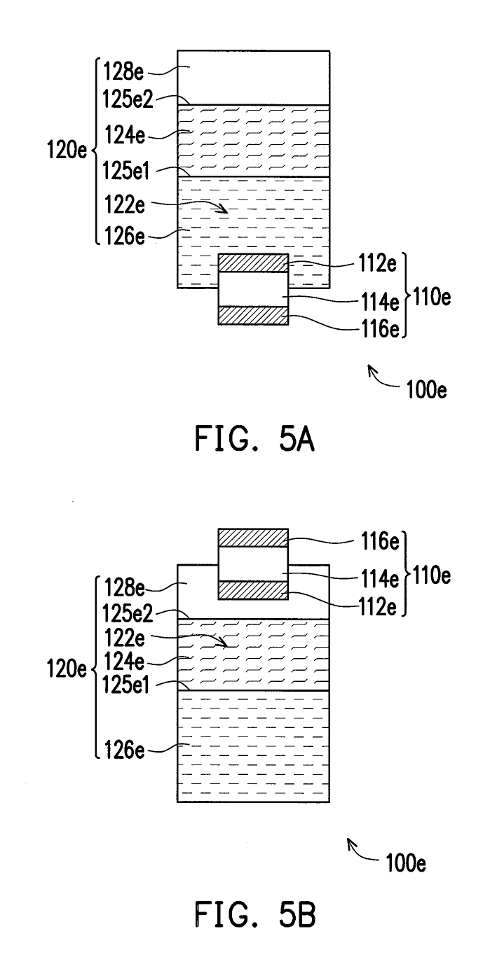

FIG. 5A is a schematic view illustrating an illumination device according to another embodiment of the present invention. FIG. 5B is a schematic view of the illumination device illustrating after reversing the transparent lampshade of FIG. 5A. Referring to FIG. 5A, the illumination device 100e of the present embodiment is similar to the illumination device 100a of FIG. 1A, and the difference between the two illumination devices is that the transparent lampshade 120e of the present embodiment further has a third fluid 128e. The first fluid 124e, the second fluid 126e and the third fluid 128e are immiscible with one another and filled up the sealed space 122e, wherein the first fluid 124e and the second fluid 126e are immiscible with each other and a fluid contact interface 125e1 is formed therebetween, and the first fluid 124e and the third fluid 128e are immiscible with each other and a fluid contact interface 125e2 is formed therebetween.

More specifically, at least one portion of the light emitting element 110e is embedded in the transparent lampshade 120e, and the light emitting element 110e and the transparent lampshade 120e define a sealed space 122e. For example, the light emitting element 110e is a vertical LED chip, wherein the light emitting element 110e consists of a first electrode 112e, a semiconductor layer 114e and a second electrode 116e. Certainly, in other embodiments, the light emitting element 110e may also be a horizontal LED chip or a flip-chip LED chip, and the present invention is not limited thereto. The transparent lampshade 120e has a first fluid 124e, a second fluid 126e and a third fluid 128e, wherein the first fluid 124e, the second fluid 126e and the third fluid 128e are immiscible with one another and flow in the sealed space 122e. The first electrode 112e and the second electrode 116e of the light emitting element 110e are respectively located at the inner side and the outer side of the sealed space 122e.

It has to be mentioned that at least one of the first fluid 124e and the second fluid 126e is a conductive liquid, for example, the second fluid 126e is a conductive liquid and the third fluid 128e is a gas. The first fluid 124e, the second fluid 126e and the third fluid 128e are immiscible with one another and flow in the sealed space 122e, and the first electrode 112e of the light emitting element 110e directly contacts with the second fluid 126e so as to form a conducting path, referring to FIG. 5A. Namely, the second fluid 126e can conduct the light emitting element 110e so that the light emitting element 110e emits lights. When the user reverses the transparent lampshade 120e, referring to FIG. 5B, the first electrode 112e of the light emitting element 110e directly contacts with the third fluid 128e to form a non-conducting path. Namely, the third fluid 128e does not conduct the light emitting element 110e and the light emitting element 110e does not emit lights.

The transparent lampshade 120e of the present invention has the first fluid 124e, the second fluid 126e and the third fluid 128e which flow in the sealed space 122e and are immiscible with one another, and the design of the transparent lampshade 120e is adapted to change the light shape of the emitted light from the light emitting element 110e. Accordingly, the user can let the light emitting element 110e to be turned on(emit lights) or off and change the light shape of the emitted light from the illumination device 100e of the present invention by reversing the transparent lampshade 120e, and so as to form illuminating regions distributed in different sizes, different shapes and different intensity. In addition, the emitted light from the light emitting element 110e may form phenomena of refraction, scattering or reflection on the fluid contact interfaces 125e1, 125e2 formed by the first fluid 124e, the second fluid 126e and the third fluid 128e, and these phenomena may also change the light shape of the emitted light from the light emitting element 110e.

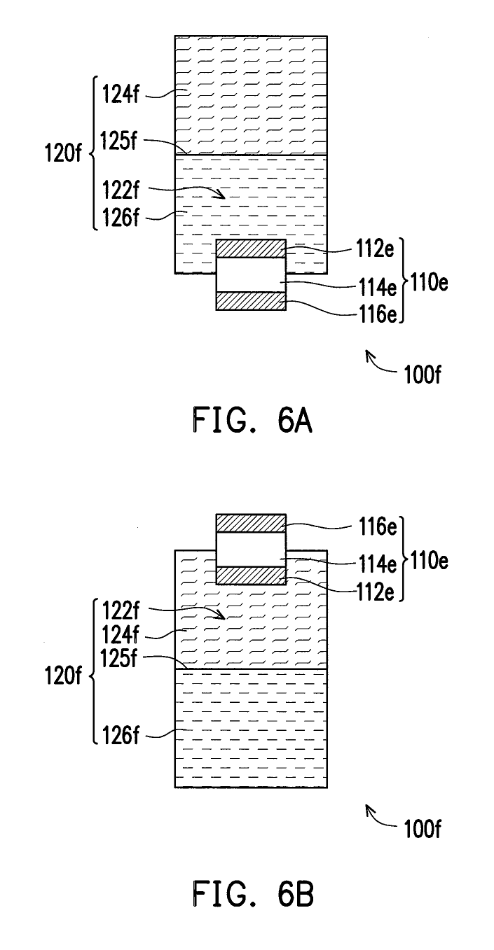

FIG. 6A is a schematic view illustrating an illumination device according to another embodiment of the present invention. FIG. 6B is a schematic view of the illumination device illustrating after reversing the transparent lampshade of FIG. 6A. Referring to FIG. 6A, the illumination device 100f of the present embodiment is similar to the illumination device 100e of FIG. 5A, and the difference between the two illumination devices is that the transparent lampshade 120f only has a first fluid 124f and a second fluid 126f, wherein the first fluid 124f and the second fluid 126f are immiscible with each other and a fluid contact interface 125f is formed therebetween.

Herein, the first fluid 124f and the second fluid 126f are fluids with different conductivity, and the light emitting element 110e directly contacts with the first fluid 124f or the second fluid 126f so as to form a conducting path or a non-conducting path. For example, the second fluid 126f is a conductive fluid, and the first fluid 124f is an insulating fluid, for example. The first fluid 124f and the second fluid 126f flow in the sealed space 122f, and the first electrode 112e of the light emitting element 110e directly contacts with the second fluid 126f so as to form a conducting path, referring to FIG. 6A. Namely, the second fluid 126f can conduct the light emitting element 110e so that the light emitting element 110e emits lights. When the user reverses the transparent lampshade 120f, referring to FIG. 6B, the first electrode 112e of the light emitting element 110e directly contacts with the first fluid 124f to form a non-conducting path. Namely, the first fluid 124f does not conduct the light emitting element 110e and the light emitting element 110e does not emit lights. Accordingly, the user can let the light emitting element 110e to be turned on(emit light) or off and change the light shape of the emitted light from the illumination device 100f of the present invention by reversing the transparent lampshade 120f, and so as to form illuminating regions distributed in different sizes, different shapes and different intensity. In addition, the emitted light from the light emitting element 110e may form phenomena of refraction, scattering or reflection on the fluid contact interface 125f formed by the first fluid 124f and the second fluid 126f, and these phenomena may also change the light shape of the emitted light from the light emitting element 110e.

In light of the foregoing, the transparent lampshade of the present invention has various fluids which flow in the sealed space and are immiscible with one another, and the design of the transparent lampshade is adapted to change the light shape of the emitted light from the light emitting element. Accordingly, the user can change the light shape of the emitted light from the illumination device of the present invention by reversing the transparent lampshade, and so as to form illuminating regions distributed in different sizes, different shapes and different intensity. Furthermore, through electrically insulated design of the light emitting elements and selecting of material properties (e.g., specific gravity, transmittance, scattering coefficient, conductivity) and volume of fluids, the light shape of the emitted light from the illumination device can be adjusted.

It will be apparent to those skilled in the art that various modifications and variations can be made to the structure of the disclosed embodiments without departing from the scope or spirit of the invention. In view of the foregoing, it is intended that the disclosure cover modifications and variations of this specification provided they fall within the scope of the following claims and their equivalents.

What is claimed is:

1. An illumination device, comprising:
at least one light emitting element; and
a transparent lampshade disposed on one side of the light emitting element and located on a light emitting path of the light emitting element, the transparent lampshade having a sealed space, a first fluid and a second fluid, wherein the first fluid is a colloidal solution, the first fluid is immiscible with the second fluid, and the first fluid and the second fluid flow in the sealed space.

2. The illumination device as claimed in claim 1, wherein both the first fluid and the second fluid are liquids and the first fluid and the second fluid fill up the sealed space.

3. The illumination device as claimed in claim 1, wherein a difference value between a specific gravity of the first fluid and a specific gravity of the second fluid is equal to or greater than 3% of the specific gravity of the second fluid.

4. The illumination device as claimed in claim 1, wherein a difference between a transmittance of the first fluid and a transmittance of the second fluid is equal to or greater than 5%.

5. The illumination device as claimed in claim 1, wherein a dispersing medium of the first fluid is liquid.

6. The illumination device as claimed in claim 1, wherein a difference value between a scattering coefficient of the first fluid and a scattering coefficient of the second fluid is equal to or greater than 5% of the scattering coefficient of the second fluid.

7. The illumination device as claimed in claim 6, wherein the first fluid comprises at least one metal particle, and a diameter of the at least one metal particle is between 1 nm and 500 nm.

8. The illumination device as claimed in claim 1, further comprising a carrier, wherein the light emitting element is disposed on the carrier and located between the carrier and the transparent lampshade.

9. An illumination device, comprising:
at least one light emitting element; and
a transparent lampshade, wherein the light emitting element is disposed in the transparent lampshade, at least one portion of the light emitting element is attached to the transparent lampshade, the transparent lampshade has a sealed space, a first fluid and a second fluid, the first fluid is a colloidal solution, the first fluid is immiscible with the second fluid, and the first fluid and the second fluid flow in the sealed space.

10. An illumination device, comprising:
at least one light emitting element; and
a transparent lampshade, wherein at least a portion of the light emitting element is embedded in the transparent lampshade, and the light emitting element and the transparent lampshade define a sealed space, the transparent lampshade has a first fluid and a second fluid, wherein the first fluid is immiscible with the second fluid, and the first fluid and the second fluid flow in the sealed space.

11. The illumination device as claimed in claim 10, wherein the light emitting element is a light emitting diode, and a first electrode and a second electrode of the light emitting diode are respectively located at an inner side and an outer side of the sealed space.

12. The illumination device as claimed in claim 11, wherein the first fluid and the second fluid are fluids with different conductivity, and the light emitting element directly contacts with the first fluid or the second fluid so as to form a conducting path or a non-conducting path.

13. The illumination device as claimed in claim 11, wherein the transparent lampshade further has a third fluid and the third fluid is a gas, at least one of the first fluid and the second fluid is a conductive liquid, and the light emitting element directly contacts with the conductive liquid or the gas so as to form a conducting path or a non-conducting path.
